(19) United States
(12) Patent Application Publication
(10) Pub. No.: US 2011/0122224 A1
(43) Pub. Date: May 26, 2011

(54) ADAPTIVE COMPRESSION OF BACKGROUND IMAGE (ACBI) BASED ON SEGMENTATION OF THREE DIMENTIONAL OBJECTS

(76) Inventor: Wang-He Lou, Tustin, CA (US)

(21) Appl. No.: 12/623,183

(22) Filed: Nov. 20, 2009

(51) Int. Cl. H04N 13/00

(52) U.S. Cl. 348/42; 348/E13.001

(57) ABSTRACT

Systems and methods for three dimensional (3D) video compression that reduce the transmission data rate of a 3D image pair to within the transmission data rate of a conventional 2D video image. The 3D video compression systems and methods described herein utilize the characteristics of the video capture systems and the Human Vision System (HVS) and reduce the redundancy of background images while maintaining the 3D objects of the 3D video with high fidelity.

### FIELD

The embodiments described herein relate generally to video compression and, more particularly, to systems and methods for compression of three dimensional (3D) video that reduces the transmission data rate of a 3D image pair to within the transmission data rate of a conventional two dimensional (2D) video image.

### BACKGROUND INFORMATION

The tremendous viewing experience afforded viewers by 3D video services is attracting more and more viewers everyday to such services. Although high quality 3D displays are becoming more affordable and 3D content is being produced faster than ever, demand for 3D video services is not being met due to the ultra high data rate (i.e., bandwidth) required for the transmission of 3D video which limits the distribution of 3D video and impairs 3D video services. 3D video requires an ultra high data rata because it includes multi-view images, i.e., at least two views (right eyed view/image and left eyed view/image). As a result, the data rate for transmission of 3D video is much higher than the data rate for transmission for conventional 2D video which only requires a single image for both eyes. Conventional compression technologies do not solve this problem.

Conventional or standardized 3D video compression techniques (e.g., MPEG-4/H.264 MVC—Multi-view Video Coding) utilize temporal predication, as well as inter-view predication, to reduce the data rate of the multi-view or image pair simulcast by about 25%. Compared to a single image for two views, i.e., 2D video, the data rate for the compressed 3D video is still 75% greater than the data rate for conventional 2D video (the single image for two views). The resulting data rate is still too high to deliver 3D content on existing broadcast networks.

Thus, it is desirable to provide systems and methods that would reduce the transmission data rate requirements for 3D video to within the transmission data rate of conventional 2D video to enable 3D video distribution and display over existing 2D video networks.

### SUMMARY

The embodiments provided herein are directed to systems and methods for three dimensional (3D) video compression that reduces the transmission data rate of a 3D image pair to within the transmission data rate of a conventional 2D video image. The 3D video compression systems and methods described herein utilize the characteristics of the 3D video capture systems and the Human Vision System (HVS) to reduce the redundancy of background images while maintaining the 3D objects of the 3D video with high fidelity.

In one embodiment, an encoding system for three-dimensional (3D) video includes an adaptive encoder system configured to adaptively compress a background image of a first base image, and a general encoder system configured to encode the adaptively compressed background image, a first 3D object of the first base image and a second 3D object of a second base image, wherein the compression of the background image by the adaptive encoder system is a function of a data rate of the encoded background image and first and second 3D objects exiting the second encoder system.

In operation, a background image of a first base image is adaptively compressed by the adaptive encoder system, and the adaptively compressed background image is encoded along with a first 3D object of the first base image and a second 3D object of a second base image by the general encoder, wherein the compression of the background image is a function of a data rate of the encoded background image and first and second 3D objects exiting the general encoder system.

Other systems, methods, features and advantages of the example embodiments will be or will become apparent to one with skill in the art upon examination of the following figures and detailed description.

### BRlEF DESCRlPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a human vision system viewing a real world object.

FIG. 2 is a schematic of a human vision system viewing a stereoscopic display.

FIG. 3 is a schematic of a capture system for 3D Stereoscopic video.

FIG. 4 is a schematic of a focused 3D object and unfocused background of a left and right image pair.

FIG. 5 is a schematic of 3D video system based on adaptive compression of background images (ACBI).

FIG. 6 is a schematic of a system and processes for ACBI based 3D video signal compression.

FIG. 7 is a flow chart of data rate control for ACBI based 3D video signal compression.

FIG. 8 is a schematic of a system and processes for ACBI based 3D video signal decompression.

FIG. 9 is a flow chart of a process for adaptively setting a threshold of difference between the pixels of the left and right view images.

FIG. 10 are histograms of the absolute differences between the left and right view images.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce systems and methods to facilitate enhanced 3D video signal compression using 3D object segmentation based adaptive compression of background images (ACBI). Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Before turning to the manner in which the present invention functions, it is believed that it will be useful to briefly review the major characteristics of the human vision system and the image capture system for stereoscopic video, i.e., 3D video.

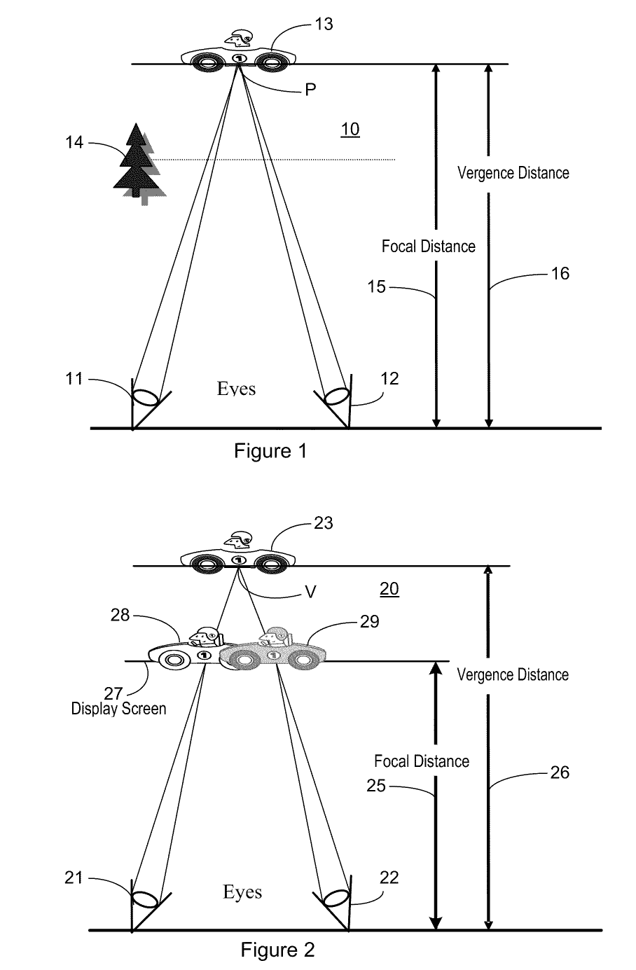

The human vision system 10 is described with regard to FIGS. 1 and 2. The human eyes 11 and 12 can automatically focus on the objects, e.g., the car 13, in a real world scene being viewed by adjusting the lenses of the eyes. The focal distance 15 is the distance to which the two eyes are focused. Another important parameter of human vision is vergence distance 16. The vergence distance 16 is the distance where the fixation axes of the two eyes converge. In the real world, the vergence distance 16 and focal distance 15 are almost equal as shown in the FIG. 1.

In real world scenes, the object of retinal image is sharpest in focus and the objects not in focus or not at focal distances are blurred. Because a 3D image includes depth, the blur degree varies according to the depth. For instance, the blur is less at a point closer to the focal point P and higher at a point farther from the focal point P. The variation of the blur degree is called blur gradient. The blur gradient is an important factor for 3D sensing in human vision.

The ability of the lenses of the eyes to change shape in order to focus is called accommodation. When viewing real world scenes, the viewer's eyes accommodate to minimize blur for the fixated part of the scene. In the FIG. 1, the viewer accommodates the eye to the object (car) 13 in focus, thus the car 13 is sharp, while the tree 14 in the foreground is blurred, because it is not focused.

For a stimulus, i.e., the object being viewed, to be sharply focused on the retina, the eye must be accommodated to a distance close to the object's focal distance. The acceptable range, or depth of focus, is roughly +/−0.3 diopters. Diopters are the viewing distance in inverse meters. (See, Campbell, F. W., The depth of field of the human eye, Journal of Modern Optics, 4, 157-164 (1957); Hoffman, D. M., et al., Vergence-accommodation conflicts hinder visual performance and cause visual fatigue, Journal of Vision 8(3):33, 1-30 (2008); Martin Bank, etc. Consequences of Incorrect Focus Cues in Stereo Displays, Information Display, pp 10-14, Vol. 24, No. 7 (July 2008)).

In 2D display systems, the entire screen is in focus at all times. With the entire screen in focus at all times, there is no blur gradient. In many 3D display systems with a flat screen, the entire screen is in focus at all times, reducing the blur gradient depth cue. However, to overcome this drawback, stereoscopic based displays 20, as depicted in FIG. 2, present separate images to each of the two eyes 21 and 22. Objects 28 and 29 in the separate images are displaced horizontally to create binocular disparity, which in turn creates a stimulus to vergence V at a vergence distance 26 beyond the focal distance 25 at the focal point, i.e., the screen 27. This binocular disparity creates a 3D sensation, because it recreates the differences in images viewed by each eye similar to the differences experienced by the eyes while viewing real 3D scenes.

3D video technologies are classified in two major catagories: volumetric and stereoscopic. In a volumetric display, each point on the 3D object is represented by a voxel that is simply defined as a three dimensional pixel within the 3D volume, and the light coming from the voxel reaches the viewer's eyes with the correct cues for both vergence and accommodation. However, the objects in a volumetric system are limited to a small size. The embodiments described herein are directed to stereoscopic video.

Stereoscopic video capture system: As noted above, stereoscopic displays provide one image to the left eye and a different image to the right eye, but both of these images are generated by flat 2D imaging devices. A pair of images consisting of a left eye image and right eye image is called a stereoscopic image pair or image pair. More than two images of a scene are called multi-view images. Although the embodiments described herein focus on stereoscopic displays, the systems and methods described herein apply to multi-view images.

In a conventional stereoscopic video capture system, cameras shoot the image by setting two sets of parameters. One set of parameters is related to the geometry of the ideal projection perspective to the physics of the camera. These parameters consist of the camera constant f (the distance between the image plane and the lens), the principal point which is the intersection point of the optic axis with the image plane in the measurement reference plane located on the image plane, the geometric distortion characteristics of the lens and the horizontal and vertical scale factors, i.e., distances between rows and between columns.

Another set of parameters is related to the position of the camera in a 3D world reference frame. These parameters determine the rigid body transformation between the world coordinate frame and camera-centered 3D coordinate frame.

Similar to the human vision system, the captured image of the object is sharpest in focus and the objects not in focus are blurred. The blur degree varies according to the depth, with there being less blur at a point closer to the focal point and higher blur at a point farther from the focal point. The blur gradient is also important factor for 3D displays. The image of objects is blurred at non focal distances.

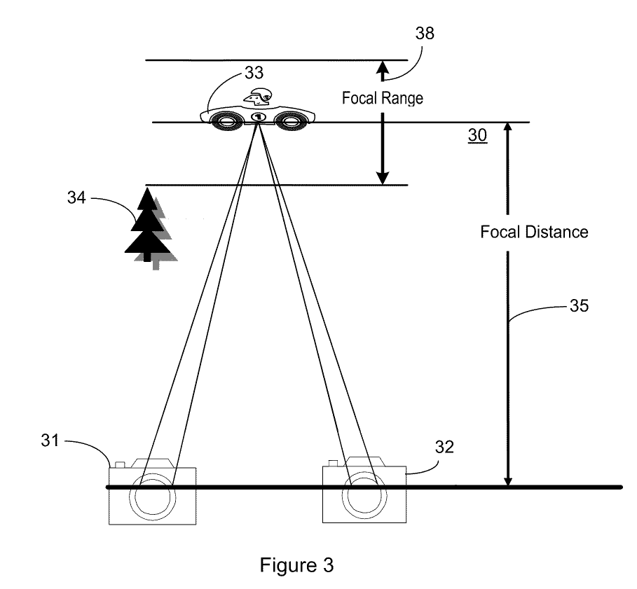

As shown in FIG. 3, in a conventional stereoscopic capture system 30, two cameras 31 and 32 take the left and right images of the real world scene. Both cameras bring different depth planes into focus by adjustment of their lenses. The object in focus, i.e., the car 33, at the focal distance 35 is sharp in each image, while the object out of focus, i.e., the tree 34 is somewhat blurred in each image. Other objects within the focal range 38 will be somewhat sharp in each image.

In view of the characteristics of the human vision system and the stereoscopic video capture system, the systems and methods described herein for compression, distribution, storage and display of 3D video content preferably maintain the highest fidelity of the 3D objects in focus, while the background and foreground images are adaptively adjusted with regard to their resolution, color depth, and even frame rate.

In an image pair, there are a limited number of 3D objects that the cameras focus on. The 3D objects focused on are sharp with details. Other portions of the image pairs are the background image. The background image is similar to a 2D image with little to no depth information because background portions of the image pairs are out of the focal range, and hence are blurred with little or no depth details. As discussed in greater detail below, by segmenting the focused 3D objects from the unfocused background portions of the image pair, compression of 3D video content can be enhanced significantly.

The blur degree and blur gradient are the basic and important concepts that can be used to separate the 3D objects (i.e., the focused portions of the image) from the background (i.e., the unfocused portions of the image) of the image. The higher blur degree portions constitute the background image. The lower blur degree portions are the focused objects. The blur gradient is the difference of blur degree between two points within the image. The higher blur gradient portions occur at the edges of focused objects. The weight is a parameter that is correlated to the location of a pixel for calculation of the blur degree.

If the object is focused, one pixel in the image is decided by one point of the object ideally. If the object is not focused, one pixel is decided by the near neighbor points of the object and the pixel is blurred and looks like a spot.

For digital images, the definition of Blur Degree is defined mathematically as follows:

Blur Degree k is the pixel matrix dimension used to determine a blurred pixel.

Blur Degree 1: the pixel is the average of matrix X±1 pixel and Y±1;

Blur Degree 2: the pixel is the average of matrix X±2 pixels and Y±2;

Blur Degree k: the pixel is the average of matrix X±k pixels and Y±k;

TABLE 1
Blur Degree k = 1, pixel locations and weight (Sum = 6).
(A) Pixel Location

| | | |
|---|---|---|
| −1, −1 | 0, −1 | 1, −1 |
| −1, 0 | 0, 0 | 1, 0 |
| −1, 1 | 0, 1 | 1, 1 |

(B) Weight

| | | |
|---|---|---|
| 0 | 1 | 0 |
| 1 | 2 | 1 |
| 0 | 1 | 0 |

TABLE 2
Blur Degree k = 2, pixel locations and weight (Sum = 20).
(A) Pixel Location

| | | | | |
|---|---|---|---|---|
| −2, −2 | −1, −2 | 0, −2 | 1, −2 | 2, −2 |
| −2, −1 | −1, −1 | 0, −1 | 1, −1 | 2, −1 |
| −2, 0 | −1, 0 | 0, 0 | 1, 0 | 2, 0 |
| −2, 1 | −1, 1 | 0, 1 | 1, 1 | 2, 1 |
| −2, 2 | −1, 2 | 0, 2 | 1, 2 | 2, 2 |

(B) Weight

| | | | | |
|---|---|---|---|---|
| 0 | 0 | 1 | 0 | 0 |
| 0 | 1 | 2 | 1 | 0 |
| 1 | 2 | 4 | 2 | 1 |
| 0 | 1 | 2 | 1 | 0 |
| 0 | 0 | 1 | 0 | 0 |

The numbers within Tables 1(A) and 2(A) correspond to the location of each pixel in relation to the center pixel of a focused object. The numbers in Tables 1(B) and 2(B) correspond to the weight of each pixel with the weight of the center pixel being highest, i.e.:

W(0,0)=2^{(blur degree)}=2^{k}

The weights of the pixels are assigned as the following:
2⁰ 2¹ 2² . . . 2^{k-1} 2^{k} 2^{k-1} . . . 2² 2¹ 2⁰
   For example: 1, 2, . . . 2^{k-1}, w (0, 0), 2^{k-1}, . . . 2, 1 on horizontal axis and vertical axis. Other cells are assigned as shown in the Tables 1 and 2.

Blur degree 0 means: k=0; W (0, 0)=1. All other weights=0. Hence, the pixel is focused and only determined by related points on the focused object.

Blur degree can be tested by shooting a non-focused image and a focused image of an object. A pixel of the non-focused image is denoted as P_{c} (0, 0). A pixel of a related point of the focused image of the object is denoted as P(0, 0).

The blurred pixel is calculated with Br=k by:

P_{b}(0,0)=1/M[Σw(i,j)P(i,j)]

Where: M=Σw(i, j);
i from −k to k;
j from −k to k.
   The Blur Degree can be determined by using a Minimum Absolute Difference calculation:

MAD=Min(|P_{b}(0,0)−P_{c}(0,0)|)

The Blur Degree (Br) can be determined by principally calculating one point. However, statistically, the Blur Degree (Br) should be measured as an area of pixels with a Minimum Sum of Absolute Difference or a Least Square Mean Error calculation.

The Blur Gradient (Bg) of two points A and B is the difference of Blur Degree at point A and Blur Degree at point B:

Bg(A,B)=Br(A)−Br(B).

Where the blur degree k is higher, the resolution of the pixel and color depth can be significantly reduced with less noticeable recognition by human vision. As a result, the compression ratio can be higher where the blur degree k is higher.

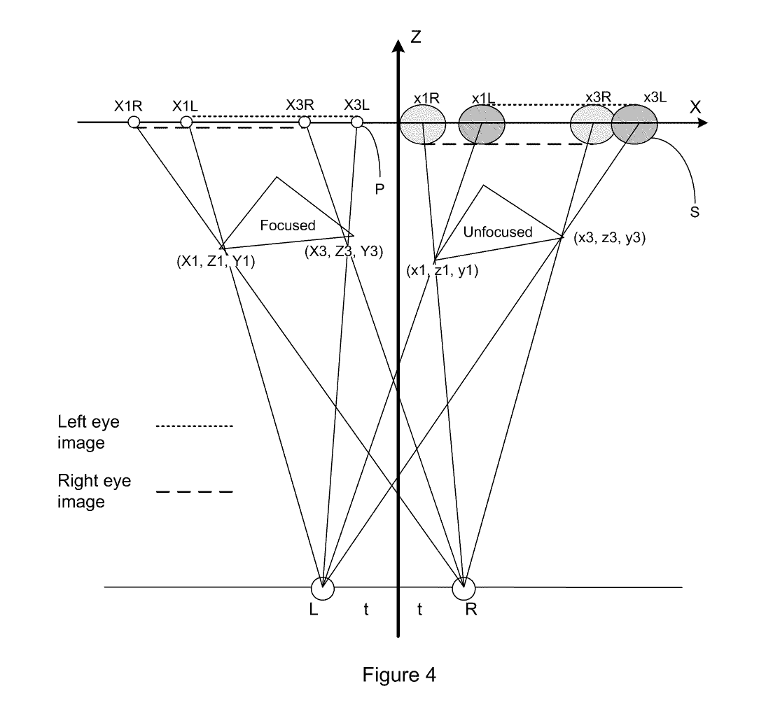

Focused objects can be separated from background portions by using the blur degree and blur gradient information of the image. The comparison of a focused object and an un-focused object is shown in FIG. 4. However, the calculations of blur degree and blur gradient can be complex and difficult, especially in single picture or image (i.e., 2D) video.

In 3D video, two or more pictures or images are viewed at the same time (e.g., a left view and a right view), i.e., each frame of a 3D video includes two or more images. The segmentation of the focused object from the background in two pictures or images is easier than 2D video and can be accomplished without calculating blur degree directly.

For digital image processing, blurring is a low pass filter that reduces the contrast of the edge and high frequency portions. In stereoscopic or 3D video, the focused objects are sharp and there is significant differences between the left and right images, while the other portions, which are out of the focal range, are smooth and exhibit less of a difference between left and right images. As shown in FIG. 4, the pixel of the focused object is one point P and the pixel of the unfocused object is a spot S. A comparison of the left and right images will distinguish the focused objects from the un-focused objects or background images. Thus, the comparison of the left and right images can be used to separate the focused objects in the left and right images from the background of the left and right images. The difference between the pixels on the focused object is larger than that on the background image because of the difference of the blur degrees. Instead of calculating the blur degree, the difference between the pixels of the left and right images can be used to segment the focused objects from the background of the left and right images. A threshold difference can be set for the image comparison to separate the 3D objects from the background. Although blur degree is not calculated, the principle of segmentation of the focused objects from the background of the images is based on the concept of blur degree and blur gradient.

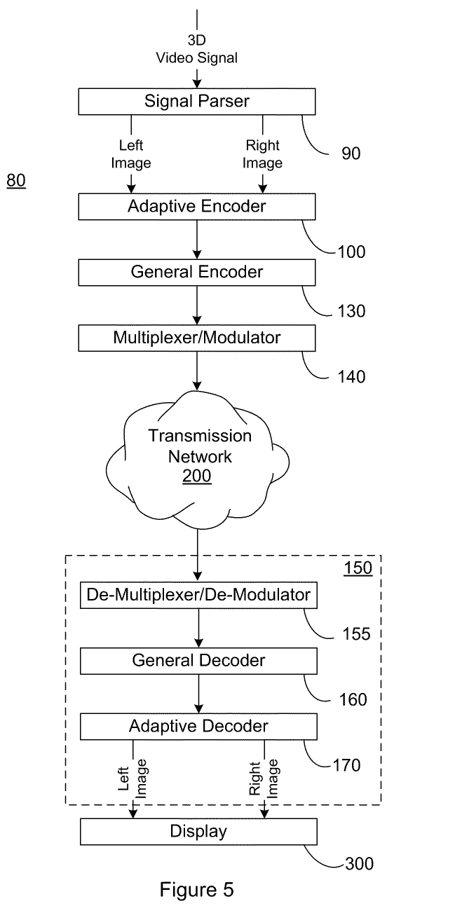

Turning in detail to FIGS. 5, 6, 7 and 8, systems and methods for compressing, transmitting, decompressing and displaying 3D video content are described and depicted. As shown in FIG. 5, a 3D video system 80 based on adaptive compression of background images (ACBI) preferably comprises a signal parser 90, an adaptive encoder 100, a general encoder 130 and a multiplexer/modulator 140 coupled to a transmission network 200. In order to display the encoded signal, the 3D video system 80 preferably includes a de-multiplexer/de-modulator 155, a general decoder 160 and an adaptive decoder 170 coupled to the transmission network 200 and a display 300. The signal parser 90, adaptive encoder 100, general encoder 130 and multiplexer/modulator 140 can be part of a single device or multiple devices as an integrated circuit, ASIC chips, software or combinations thereof. Similarly, the de-multiplexer/de-modulator 155, general decoder 160 and adaptive decoder 170 can be part of a single device such as a receiver 150 or multiple devices as an integrated circuit, ASIC chips, software or combinations thereof.

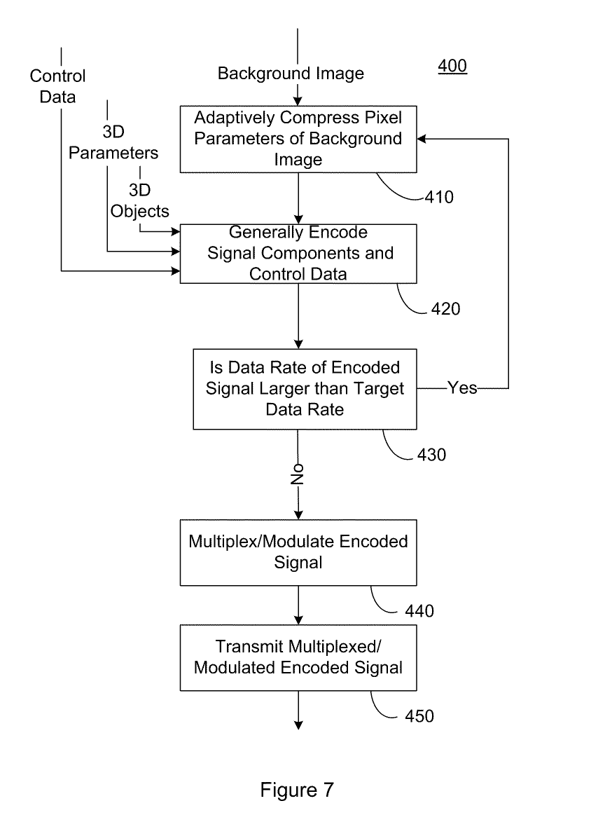

The signal parser 90 parses the 3D video signal into left and right images. The adaptive encoder 100 segments the 3D objects from background images and encodes or compresses the background image. The adaptively encoded signal is then encoded or compressed by the general encoder 130. If, however, as depicted in FIG. 7, the data rate of the encoded signal exiting the general encoder 130 is greater than the data rate capabilities of a transmission network, e.g., the bit rate in ATSC is about 19 mega bits per second (mbps), the adaptive encoder 100 alters its encoding parameters and encodes or compresses the background image again in accordance with the new encoding parameters. If the data rate of the encoded signal exiting the general encoder 130 is less than or equal to the data rate capabilities of the transmission network, the multiplexer/modulator 140 then multiplexes and modulates the generally encoded signal before the signal is transmitted over the transmission/distribution network 200. Once received at a display end of the system 80, the multiplexed and modulated signal is de-multiplexed and de-modulated by the de-multiplexer/de-modulator 155. The general decoder 160 then decodes the encoded signal and the adaptive decoder 170 adaptively decodes the adaptively encoded background image and combines the background image with the left and right objects to form left and right image pairs. The image pair is then transmitted to the display 300 for display to the user.

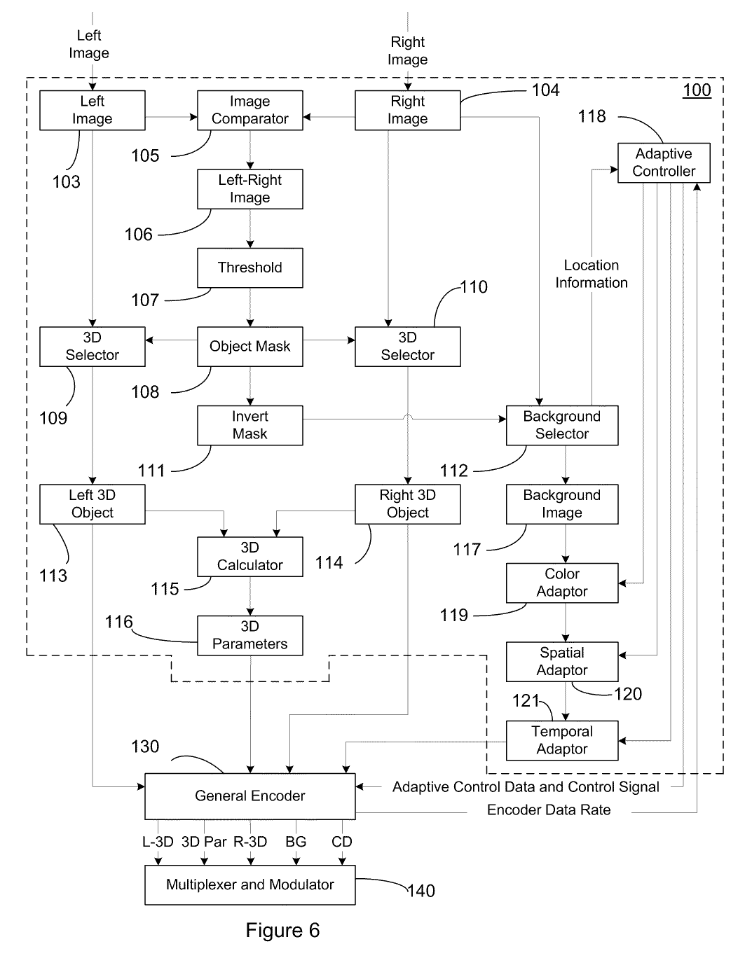

Referring to FIG. 6, a system and process block diagram of an ACBI encoder 100 is provided. The ACBI encoder 100 receives left and right images from the signal parser 90 (see FIG. 4) and stores them in left and right image frame memory blocks 103 and 104. An image comparator 105 compares the left and right images pixel by pixel. The parameters of each pixel to be compared by the comparator are determined by the picture or video classes, e.g., R G B or Y Pr Pb for color pictures. In comparing the pixels of the left and right images, the comparator 105 calculates the differences between the parameters of the pixels of left and right view images. For examples, in the R G B case:

Diff=|Rl−Rr|+|Gl−Gr|+|Bl−Br|

In the Y Pr Pb case,

Diff=|Yl−Yr|

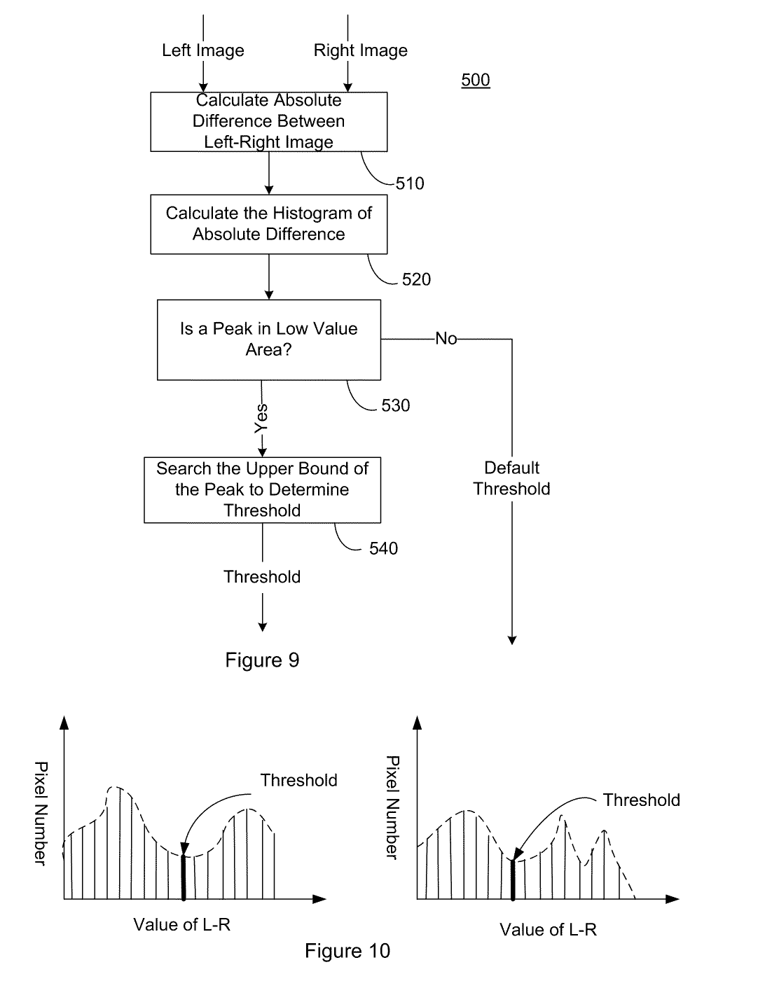

The differences between the parameters of each pixel of the left and right images are sent to a L-R image frame memory block 106 and then passed to a threshold comparator 107. The threshold of difference between the parameters used by the threshold comparator 107 is set either by previous information or by adaptive calculations. The threshold of difference usually depends on the 3D video sources. If the 3D video contents created by computer graphics, such as video games and animation film, the threshold of difference is higher than that of the 3D video contents by movie and TV cameras. Hence, the threshold of difference can be set according to the 3D video sources. More robust algorithms can be used to set the threshold. For example, an adaptive calculation of threshold 500 is presented in FIGS. 9 and 10. FIG. 9 is the flow chart of the adaptive calculation. The absolute difference between the left and right images are calculated at step 510. Then the histogram of the absolute difference is calculated at step 520. Example histograms are shown in FIG. 10. Next, step 530 determines whether there is a peak in the low value area of the histogram. Normally, there is one peak in the low value of the histogram because the differences of the background pixels are similar due to blurring and the background area is large. If no peak is found in the low value area, then a default threshold is used at 107 in FIG. 6. If one peak is found in low value area, then step 540 searches the upper bound of the peak shown in FIG. 10. The bound of the peak is then used as the threshold at 107 in FIG. 6.

If the difference between the left and right pixels at the same coordinates is larger than the threshold value, i.e., the left and right pixels are pixels of the focused objects, then the threshold comparator 107 sets the mask data for the same pixel coordinates to 1, and, if less than the threshold, i.e., the left and right pixels are pixels of the background, the threshold comparator 107 sets the mask data for the same pixel coordinates to 0. The threshold comparator 107 passes the mask data onto an object mask generator 108 which uses the mask data to build an object mask or filter.

The left image is retrieved from the left image frame memory block 103 and processed by a 3D object selector 109 using the object mask received from the object mask generator 108 to detect or segment the 3D objects from the background of the left image, i.e., the pixels of the background of the left image are set to zero by the 3D object selector 109. The 3D objects retrieved from the left image are sent to a left 3D object memory block 113.

The right image is retrieved from the right image frame memory block 104 and processed by a 3D object selector 110 using the object mask received from the object mask generator 108 to detect or segment the 3D objects from the background of the right image, i.e., the pixels of the background of the right image are set to zero by the 3D object selector 110. The 3D objects retrieved from the right image are sent to a right 3D object memory block 114.

The 3D objects of the left and right images are passed along to a 3D parameter calculator 115 which calculates or determines the 3D parameters from the left object image and right object image and stores them in a 3D parameter memory block 116. Preferably, the calculated 3D parameters may include, e.g., parallax, disparity, depth range or the like.

Background image segmentation: The 3D object mask generated by the 3D object mask generator 108 is passed along to a mask inverter 111 to create an inverted mask, i.e., a background segmentation mask or filter, from the 3D object mask by a inverting operation of changing zero to one and one to zero in the 3D object mask. A background image is then separated from the base view image by a background selector 112 using the right image passed from the right image frame memory block 104 and the inverted or background segmentation mask. The background selector 112 passes the segmented background image retrieved from the base view image to a background image memory block 117 and background pixel location information to an adaptive controller 118. The location information of the background is used by the adaptive controller 118 to determine the pixels to be processed by the color 119, spatial 120 and temporal 121 adaptors. The pixels of the 3D object, which are set to zero by the background selector 112, are skipped by the color 119, spatial 120 and temporal 121 adaptors.

In real world video, the size of focused 3D objects within a given image changes dynamically. The adaptive controller 118 adaptively controls the color adaptor 119, spatial adaptor 120 and temporal adaptor 121 as a function of the size of the focused 3D objects in a given image and the associated data rate. The adaptive controller 118 receives the pixel location information from the background selector 112 and a data rate message from the general encoder 130, and then sends a control signal to the color adaptor 119 to reduce the color bits of each pixel of the background image. The color bits of the pixels of the background image are preferably reduced one to three bits depending on the data rate of the encoded signal exiting the general encoder 130. The data rate of general encoder is the bit rate of the compressed signal streams including video, audio and user data for specific applications. Typically, a one bit reduction is preferable. If the data rate of the encoded signal exiting the general encoder 130 is higher than specified for a given transmission network, then two or three bits are reduced.

The adaptive controller 118 also sends a control signal to the spatial adaptor 120. The spatial adaptor 120 will sub-sample the pixels of the background image for transmission and reduce the resolution of the background image. In the example below, the pixels of the background image are reduced horizontally and vertically by half. The amount the pixels are reduced is also dependent on the data rate of the encoded signal exiting the general encoder 130. If the data rate of general encoder 130 is still higher than the specified data rate after the color adaptor 119 has reduced the color bits and the spatial adaptor 120 has reduced the resolution, then the temporal adaptor 121 may be used to reduce the frame rate of the background image. The data rate will be significantly reduced if the frame rate decreases. Since the change of frame rate may degrade the video quality, it is typically not preferable to reduce the frame rate of the background image. Accordingly, the temporal adaptor 121 is preferably set to a by-passed condition.

FIG. 7 depicts the steps in the encoding and transmitting process 400 for background image using adaptive control based compression. As depicted, the pixel parameters of the background image i.e. color bits and resolution, are adaptively compressed at step 410 as discussed above with regard to FIG. 6. The adaptively compressed pixels of the background image are generally encoded at step 420 along other signal components, i.e., the 3D objects and parameters, and the control data from the adaptive controller 118. At step 430, the system determines if the data rate of the encoded signal leaving the encoder 130 in FIG. 6 is greater than a target data rate or a specified data rate capability of a transmission network. If the data rate is greater than the target data rate, step 410 is repeated on the pixels of the background image with different compression parameters set. In step 430, the general encoder 130 in FIG. 6, sends the adaptive controller 118 the data rate of the encoded signal exiting the general encoder 130, and depending on the data rate, the adaptive controller 118 may instruct the color adaptor 119 to increase the color bit reduction, the spatial adaptor 120 to increase the resolution reduction, and the temporal adaptor 121 to reduce the frame rate.

If the data rate of the encoded signal leaving the encoder 130 in FIG. 6 is not greater than a target data rate or a specified data rate capability of a transmission network, the adaptive controller 118 signals the general encoder 130 to release the encoded signal components and data to the multiplexer/modulator 140, which, at step 440 modulates/multiplexes the encoded signal and data, which is then transmitted at step 450 over the network 200 (FIG. 5).

Because the background image is out of focus and blurred, the resolution and color depth can be lower than that of the 3D objects with minimal recognition, if at all, by the human vision system. As noted above, the color adaptor 119 receives the background image and preferably reduces the color bits of the background image for transmission. For example, if the color depth is reduced from 8 bits per color to 7 bits per color, or 10 bits per color to 8 bits per color, the data rate will be reduced approximately one-eight (⅛) or one-fifth (⅕). The color depth can be recovered with minimal loss by adding zero in the least significant bits in the decoding.

Because the background image is out of focus and blurred, the resolution of the background image is also preferably reduced for transmission. As noted above, the spatial adaptor 120 receives the background image with reduced color bits and preferably reduces the pixels of the background image horizontally and/or vertically. For example, in HD format with a resolution of 1920×1080, it is possible to reduce the resolution of the background image to half in each direction and recover by the special interpolation in decoding with minimal recognition, if at all, by the human visual system.

In the cases of non-high quality video, the frame rate of background image can be reduced for transmission. A temporal adaptor 121 can be used to determine which frames to transmit or which frames not to transmit. In the receiver, the frames not transmitted can be recovered by the temporal interpolation. It is, however, not preferable to reduce the frame rate of the background image as it may impair the motion composition that is used in major video compression standards, such as MPEG. Thus, the temporal adaptor 121 is preferably by-passed in the adaptive compression of the background image.

After the processing of adaptive compression of background image, the data rate will advantageously be significantly reduced. Some examples are presented to explain the data reduction.

### Example 1

Typically, the average area encompassed by 3D objects is less than one-fourth (¼) the area of the entire image. If the 3D objects occupy ¼ the area of the entire image, the background image occupies three-fourths (¾) of the entire image. Thus, three out of four pixels are background.

If the 8 color bits per pixel is reduced to 7 color bits per pixel by the color adaptor 119, the data rate of the background image is reduced to seven-eighths (⅞) of the original data rate of the background image. A single color bit reduction in background is typically not noticeable to the human vision system.

In HD format of 1920×1080, the resolution of the background image is reduced horizontally by one-half (½) and vertically by one-half (½) to a resolution of 960×540 for transmission. The transmitted pixels of the background image are reduced to one-fourth (¼) of the pixels of the original background image as a result.

In this example, the temporal adaptor 121 is by-passed and does not contribute the data reduction for transmission.

The 3D objects of the image are preferably transmitted with the highest fidelity using conventional compression and, thus, the pixels of the 3D objects, which comprise one-fourth (¼) of the pixels of the entire image, are kept at the same data rate. The adaptive compression of background image (ACBI) based data rate reduction is calculated as follows:

Percentage of original data rate of 3D objects (¼ area) in the right image:

¼×100%=25%

Percentage of original data rate of background image (¾ area) in the right image:

¾×[(1−⅛)×(1−¾)]×100%=0.75×0.875×0.25×100%=16.4%

Percentage of the original data rate of right image is

25%+16.4%=41.4%

The data rate of one of the images of the image pair, i.e., the right image, with ACBI is only 41.4% of the data rate of the original right image without ACBI. Because the background images of the left and right images are substantially the same, the background of the right image can be used to generate the background of the left image at the receiver. The data rate of the image pair with ACBI can then be calculated as a function of the data rata of a single image by adding the data rate of the 3D objects for the second image of the image pair, i.e., the left image, which is also 25% of the data rate of the original image, to the data rate of the right image with ACBI:

Percentage of the original data rate of a single image

41.4%+25%=66.4%

As a result, the data rate of an image pair with ACBI is advantageously only 66.4% of one image without ACBI.

### Example 2

In this example, the vertical resolution of the background is reduced, while the horizontal resolution is not. All other parameters remain the same as Example 1. Accordingly, the percentage of original data rate of background image (¾ area) in the right image is:

¾×[(1−⅛)×(1−½)]×100%=0.75×0.875×0.5×100%=32.8%

The percentage data rate of right image is:

25%+32.8%=57.8%

The data rate of one of the images of the image pair, i.e., the right image, with ACBI is 57.8% of the right image without ACBI. As noted above, the data rate of the image pair with ACBI can be calculated as a function of the data rata of a single image by adding the data rate of the 3D objects for the second image of the image pair, i.e., the left image, which is also 25% of the data rate of the original image, to the data rate of the right image with ACBI:

Percentage of the original data rate of a single image

57.8%+25%=82.8%.

As a result, the data rate of an image pair with ACBI is advantageously only 82.8% of one image without ACBI.

### Example 3

In this example the 3D objects occupy one-half (½) the area of the entire image statistically and the background image only occupies one-half (½) the area of the entire base image. Thus, half the pixels of the image are background.

Percentage of original data rate of 3D objects (½ area) in the right image:

½×100%=50%

The 8 color bits per pixel of the background image is reduced by one bit; the resolution of the background image is reduced horizontally by one-half and vertically by one-half. Percentage of original data rate of background image (½ area) in the right image:

½×[(1−⅛)×(1−¾)]×100%=0.50×0.875×0.25×100%=11%

Percentage of the original data rate of right image is

50%+11%=61%

Percentage of the original data rate of single image is

61%+50%=111%

As a result, the data rate of an image pair with ACBI is advantageously only 111% of one image without ACBI. In the case where the average data rate is higher than the 2D video bandwidth, the adaptive controller 173 will issue the command to further reduce the color bits and the spatial resolution of the background image, and even reduce the frame rate of background image temporarily to avoid the data overflow in worst case scenario.

The 3D content encoded by ACBI and existing compression technologies, will be able to be delivered in most instances on existing 2D video distribution or transmission networks 200. In real world videos, the size of focused 3D objects change dynamically. The data rates change according to the size of the focused 3D objects. Since the 3D object is likely less than half of the image in most video scenes, the overall average data rate after ACBI compression will be equal to or less than 2D video bandwidth. It is more likely, however, that the 3D objects in actual 3D videos are less than one-fourth (¼) area of the entire image, so it is very promising that the data rate can be compressed more efficiently.

It is important to transmit the 3D parameters from sources to receivers. The 3D parameters support the decoders and displays to render the 3D scene correctly.

### Examples of 3D parameters of interest may include

Parallax: The distance between corresponding points in two stereoscopic images as displayed.

Disparity: the distance between conjugate points on a stereo imaging devices or on recorded images,

Depth Range: The range of distances in camera space from the background point producing maximum acceptable positive parallax to the foreground point producing maximum acceptable negative parallax.

Some 3D parameters are provided by the video capture system. Some 3D parameters may be calculated using the 3D objects of the left and right images.

General Encoding after ACBI processing: After segmentation of the 3D objects and ACBI, the 3D objects and ACBI of the left and right images are encoded by a general encoder 130. The general encoder 130 can be a single encoder or multiple encoders or encoder modules, and preferably uses standard compression technologies, such as MPEG2, MPEG-4/H.264 AVC, VC-1, etc. The 3D objects of left and right views are preferably encoded with full fidelity. Since 3D objects of left and right views are generally smaller than the entire image, the data rate needed to transmit the 3D objects will be lower. The background image processed by the ACBI to reduce its data rate is also sent to the general encoder 130.

The 3D parameters are preferably encoded by the general encoder 130 as data packages. The adaptive controller 118 sends the control data and control signal to the general encoder 130, while the general encoder 130 feeds back the data rate of the encoded signal exiting the general encoder 130 to the adaptive controller 118. The adaptive controller 118 will adjust the control signals to the color adaptor 119, spatial adaptor 120 and temporal adaptor 121 according to the data rate of the encoded signal exiting the general encoder 130.

The output from the general encoder 130 includes encoded right image of 3D objects (R-3D), encoded left image of 3D objects (L-3D), and encoded data packages containing the 3D parameters (3D Par), as well as encoded background images (BG) and control data (CD) as described below. The encoded background image, the encoded 3D objects of the stereoscopic image pair, the 3D parameters and the control data from the adaptive controller 118 are multiplexed and modulated by the multiplexer and modulator 140, then sent to a distribution network 200 as depicted in FIG. 5, such as off air broadcasters, Cables and Satellite Networks, and then received by the receiver 150.

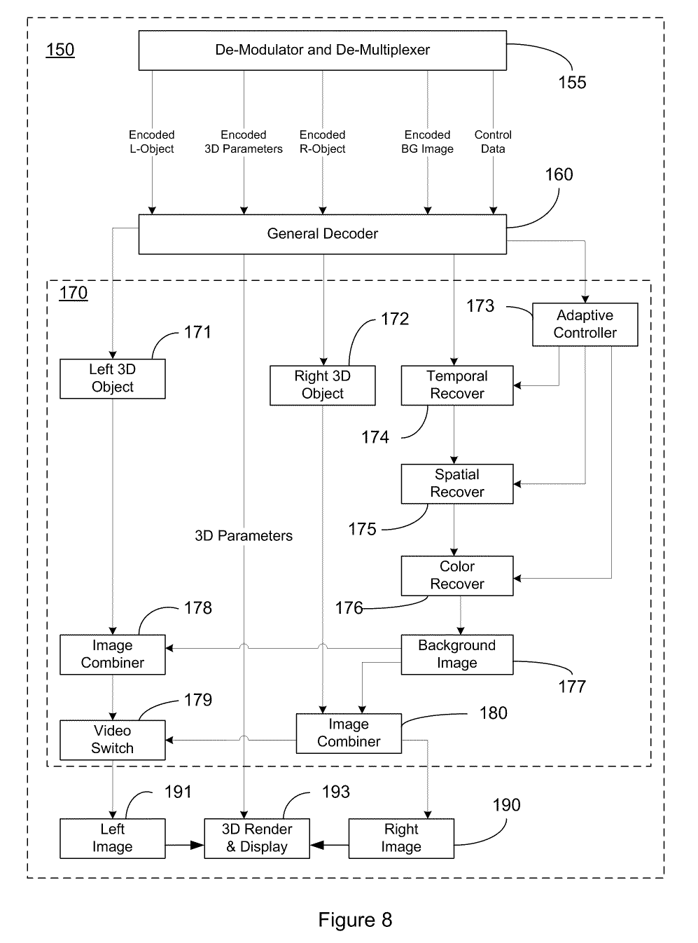

Restoration of left view and right view images: Referring to FIG. 8, all the video data and 3D parameters received are demodulated and de-multiplexed by the demodulator and de-multiplexer 155 and sent to the general decoder or decoders 160 that use standard decompression technologies, such as MPEG2, MPEG-4/H.264 AVC, VC-1, etc.

The encoded left and right 3D objects of the left and right images are decoded by the general decoder and passed to and stored in the left and right 3D object memories 171 and 172. The background image and the ACBI control data are decoded by the general decoder 160 as well. The ACBI control data is sent to an adaptive controller 173. If the temporal adaptor 121 reduced the frame rate of the background image, the frame rate information is decoded by the general decoder and sent to the adaptive controller 173, which sends a control signal to a temporal recovery module 174. The adaptive controller 173 also sends the spatial reduction and color bit reduction information to a spatial recovery module 175 and a color recovery module 176.

The background image is sent to the temporal recovery module 174. The temporal recovery module 174 is preferably a frame converter that converts the frame rate back to the original video frame rate by frame interpolation. As previously discussed, the frame conversion involves complex processes, including motion compensation, and is preferably by-passed in the compression process.

Spatial recovery is performed by the spatial recovery module 175 by restoring the missing pixels by interpolation with near neighbor pixels. For example, in the background picture, some of pixels are decoded, while others are missed because sub-sampling in the spatial adaptor 120.

TABLE 3
The interpolation of background pixels.

| | | | | |
|---|---|---|---|---|
| 0, 0 | 1, 0 | 2, 0 | 3, 0 | 4, 0 |
| 0, 1 | 1, 1 | 2, 1 | 3, 1 | 4, 1 |
| 0, 2 | 1, 2 | 2, 2 | 3, 2 | 4, 2 |
| 0, 3 | 1, 3 | 2, 3 | 3, 3 | 4, 3 |
| 0, 4 | 1, 4 | 2, 4 | 3, 4 | 4, 4 |

In the Table 3, the following pixels are decoded by the general decoder:
P (0, 0), P (2, 0), P (4, 0),
P (0, 2), P (2, 2), P (4, 2),
P (0, 4), P (2, 4), P (4, 4).
   The following pixels are recovered by interpolation:

P(1,0)=½[P(0,0)+P(2,0)]

P(1,2)=½[P(0,2)+P(2,2)]

P(0,1)=½[P(0,0)+P(0,2)]

P(2,1)=½[P(2,0)+P(2,2)]

P(1,1)=¼[P(1,0)+P(1,2)+P(0,1)+P(2,1)]

All missing pixels can be recovered by the same method. The interpolation methods are not limited to the above algorithm. Other advanced interpolation algorithms can be used as well.

Color recovery is performed by the color recovery module 176 using a bit shifting operation. If the decoded background image is 7 bits, 8 bits of color can be recovered by a left shift of one bit, while 10 bits of color can be recovered by a left shift of three bits.

The background image is sent to an image combiner 178 with the left 3D object to restore the left image. The background image is also sent to another image combiner 180 with the right 3D object to restore the right image. As a result, the left and right images of the stereoscopic image pair are decoded and restored.

The right view image and left view image are shown as blocks 190 and block 191. The encoded 3D parameters are de-multiplexed by de-multiplexer 155, decoded by decoder 160 and sent to a 3D rendering and display module 193. The 3D parameters are used to render the 3D scene correctly. System or viewer manipulation of the 3D parameters may be provided to alter the quality of the 3D rendering and the viewer's 3D viewing experience.

2D backward compatibility of ACBI: To enable backward compatibility with 2D video, a video switch 179 is added. The left view image and right view image are sent to the video switch 179 from the image combiners 178 and 180. The left image block 191 can display either decoded left view image or the decoded right (base) view image. If the left image block 191 displays the decoded left view image, the mode is 3D view. If the left image block 191 displays the decoded right view image, the mode is 2D view.

The ACBI system and process based on segmentation of 3D objects described herein is truly backward compatible with 2D video bandwidth constraints. For broadcast systems which have significant bandwidth constraints, the 3D content of the video signal could be distributed in a backward compatible manner where the 2D component is distributed. The additional bandwidth requirement for delivering the full 3D content rather than just the 2D component of the content is minimized. The estimation of data rate reduction discussed above showed that the compressed 3D video using ACBI fit within current broadcaster bandwidth used for 2D video because ACBI reduced the data rate significantly.

Seamless Switching Between 2D and 3D Modes:

3D to 2D switch—A viewer is watching 3D content in 3D mode and decides to change to a 2D program. The ACBI system permits a seamless transition from 3D viewing to 2D viewing. The receiver 150 can switch the left view to the base view (right view) image by the video switch 179. The left view image becomes the same as right view image, and then 3D is seamlessly switched to 2D. The viewer can use the remote controller to switch the 3D mode to 2D mode; the left view will be switched to right view. Both eyes will watch the same base view video.

2D to 3D switch—A viewer is watching 2D content in 2D mode and decides to change to 3D program. The system permits a seamless transition from 2D viewing to 3D viewing. The receiver 150 can switch the left view from the base view (right view) image to left view image by the video switch block 179, and then 2D is seamlessly switched to 3D mode.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. An encoding process for three-dimensional (3D) video comprising the steps of
adaptively compressing a background image of a first base image in a first encoder system, and
encoding in a second encoder system the adaptively compressed background image, a first 3D object of the first base image and a second 3D object of a second base image, wherein the compression of the background image is a function of a data rate of the encoded background image and first and second 3D objects exiting the second encoder system.

2. The process of claim 1 further comprising the step of segmenting the first and second 3D object from the first and second base images.

3. The process of claim 2 wherein the step of segmenting includes creating a 3D object mask.

4. The process of claim 3 wherein the step of creating a 3D object mask includes comparing each pixel of the first base image with a corresponding pixel in the second base image.

5. The process of claim 1 further comprising the step of segmenting the background image from the first base image.

6. The process of claim 5 wherein the step of adaptively compressing the background image includes reducing the color bits of each pixel of the background image.

7. The process of claim 6 wherein the step of adaptively compressing the background image further includes reducing the resolution of the background image.

8. The process of claim 7 wherein if the data rate of the encoded background image and first and second 3D objects exiting the second encoder system is greater than a predetermined data rate, increasing the reduction of the color bits of each pixel of the background image and the reduction of the resolution of the background image.

9. The process of claim 8 further comprising the step of reducing the frame rate of the background image.

10. The process of claim 9 further comprising the step of modulating and multiplex the encoded background image and first and second 3D objects exiting the second encoder system.

11. An encoding system for three-dimensional (3D) video comprising
a first encoder system configured to adaptively compress a background image of a first base image, and
a second encoder system configure to encoded the adaptively compressed background image, a first 3D object of the first base image and a second 3D object of a second base image, wherein the compression of the background image by the first encoder system is a function of a data rate of the encoded background image and first and second 3D objects exiting the second encoder system.

12. The system of claim 11 where in the first encoder system is further configured to segment the first and second 3D objects from the first and second base images and the background image from the first base image.

13. The system of claim 12 where in the first encoder system is further configured to reduce the color bits of each pixel of the background image.

14. The system of claim 13 where in the first encoder system is further configured to reduce the resolution of the background image.

15. The system of claim 14 where in the first encoder system is further configured to reduce the frame rate of the background image.

16. The system of claim 9 further comprising a modulator/multiplexer configured to modulate and multiplex the encoded background image and first and second 3D objects exiting the second encoder system.
